(19) United States
(12) Patent Application Publication
(10) Pub. No.: US 2007/0045431 A1
(43) Pub. Date: Mar. 1, 2007

(54) Occupancy-based zoning climate control system and method

(75) Inventors: John Gilman Chapman JR., Delaware, OH (US); Nicholas Ashworth, Dublin, OH (US); Robert Burt, Columbus, OH (US); Tony Gray, Dublin, OH (US); Phillip Ryan Wagner, Baltimore, OH (US); Joseph P. Rao, Dublin, OH (US); George N. Catlin, Grove City, OH (US)

Correspondence Address: REINHART BOERNER VAN DEUREN P.C., 2215 PERRYGREEN WAY, ROCKFORD, IL, 61107, US

(73) Assignee: Ranco Incorporated of Delaware, Wilmington, DE (US)

(21) Appl. No.: 11/394,581

(22) Filed: Mar. 31, 2006

Related U.S. Application Data
(63) Continuation-in-part of application No. 11/215,927, filed on Aug. 31, 2005.

(51) Int. Cl. G05D 23/19; G05D 23/12; G05D 23/00; F24F 11/053

(52) U.S. Cl. 236/46 C; 236/94; 236/51; 236/1 C

(57) ABSTRACT

A control system for managing a heating, ventilating and air conditioning (HVAC) system based on occupancy of an area is provided. The occupancy may be determined by anticipated programming based on time of day zoning, and/or by actual sensed occupancy. In the later, the control system includes an occupancy sensor that communicates with a programmable thermostat. The occupancy sensor is disposed in the area and senses a state of occupancy of the area. The programmable thermostat instructs the HVAC system to adjust the temperature of the area within the structure based on the state of occupancy of that particular area to enhance occupant comfort and energy efficiency. The thermostat may also include programming modes or scripts that may be run to adjust operational control when abnormal occupancy conditions are sensed. Controllable dampers may also be used by the thermostat to achieve micro zoning control of the HVAC system.

### CROSS-REFERENCE TO RELATED PATENT APPLICATIONS

This patent application is a continuation-in-part of co-pending U.S. patent application Ser. No. 11/215,927, filed Aug. 31, 2005, the teachings and disclosure of which are hereby incorporated in their entireties by reference thereto.

### FIELD OF THE INVENTION

The present invention relates generally to heating, ventilating, and air conditioning (HVAC) control systems, and more particularly to HVAC zoning control systems that regulate the temperature of different zones throughout a dwelling or commercial structure.

### BACKGROUND OF THE INVENTION

In most residential dwellings and many commercial structures a single thermostat is used to control the heating, ventilating, and air conditioning (HVAC) system to regulate the temperature within the dwelling. While this solution performs adequately for many consumers, it does not actually regulate the temperature in each of the different rooms or areas of the dwelling or structure particularly well. This is a result of many factors including the layout of the dwelling, how many floors are occupied, and where the thermostat is located within the dwelling or structure.

In a typical dwelling or structure, the thermostat is located in a hallway or other central area of the house. The thermostat senses the temperature at its location and controls the HVAC system to maintain the desired temperature at that location. Unfortunately, while the temperature regulation provided by the thermostat is typically very good at that location, often the occupants of the dwelling are not in the same room or location with the thermostat. Therefore, these occupants may experience wide temperature variations at their location despite the fact that the temperature is well maintained at the point of installation of the thermostat itself. This problem is particularly acute in two story dwellings where the thermostat is located on the ground floor. Since hot air rises, many consumers in such a dwelling with a typical thermostat installation complain of high temperatures on the second floor, despite the fact that at the point of installation of the thermostat the temperature is well regulated to the desired set point.

To overcome this problem, many HVAC systems now include a remote temperature sensor that may be installed in a room that is most typically occupied by the residents. In this way, the temperature in this “occupied” room can now be regulated based on the temperature sensed by the remote sensor even though the thermostat may be located in a different area of the dwelling. The thermostat in such a system is programmed to use the temperature sensed by the remote sensor rather than the temperature sensed by its internal sensor to control the HVAC system. In such a system, the temperature in the “occupied” room is now well regulated to the desired temperature set point. Unfortunately, this type of control system has significant drawbacks. For one, the residents might very well be in a room other than the one that is most typically occupied at that particular time of the day. If this occurs, then the supposedly “occupied” room is well controlled with regard to the set point while the room that is actually occupied by occupants is not.

There exists therefore, a need in the art for a HVAC control system that is capable of regulating the temperature in various areas of a dwelling based on the sensed or detected occupancy of those areas during different times of the day.

The invention provides such a sensed occupancy zoning climate control system and method. These and other advantages of the invention, as well as additional inventive features, will be apparent from the description of the invention provided herein.

### BRIEF SUMMARY OF THE INVENTION

The present invention provides a new and improved HVAC control system that overcomes the above-described and other problems existing in the art. More particularly, the present invention provides a new and improved HVAC control system that provides occupancy zoning control to better regulate the temperature of the zone in which occupants are at different times of the day to improve overall occupant comfort throughout the dwelling or structure. Even more particularly, the present invention provides a new and improved occupancy zoning control system that provides increased comfort to the occupants and that improves energy efficiency of the HVAC system.

In one embodiment of the invention, a control system that employs one or more occupancy sensors and a programmable thermostat to sense a state of occupancy of one or more rooms is provided. Depending on the sensed state, the control system operates to regulate the temperature of that room for comfort or efficiency. If the thermostat determines that there is no one home by monitoring the inputs from the occupancy sensors, the thermostat sets back the temperature control to a more energy efficient mode of operation to conserve energy. To provide temperature sensing, one or more remote temperature sensors may be used to provide the thermostat with an accurate temperature reading in the occupied areas of the dwelling.

In another embodiment of the present invention, the system includes motor or solenoid controlled dampers that are controlled by the thermostat. These dampers may be wired, or preferably in wireless communication with the thermostat. Through the use of such dampers, micro-zones may be created in the dwelling to better regulate the temperature and therefore the comfort of the occupants. Such dampers may also be controlled by the thermostat for time of day zoning to achieve the same goals without utilizing occupancy sensors.

In yet a further embodiment of the present invention, the thermostat includes special programming scripts or programmed control schemes that account for different sensed conditions to increase the comfort of the occupants. These scripts or control schemes differ from the regular hold or programmed mode of operation of the thermostat.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a top view illustration of an embodiment of a thermostat constructed in accordance with the teachings of the present invention;

FIG. 2 is a simplified dwelling diagram illustrating principles of the present invention;

FIGS. 3-16 illustrate user display screens generated by and usable with the embodiment of the thermostat of the present invention illustrated in FIG. 1 for programming the time of day zoning control of the HVAC system; and

FIG. 17 is a simplified dwelling diagram illustrating principles of one embodiment of the present invention.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

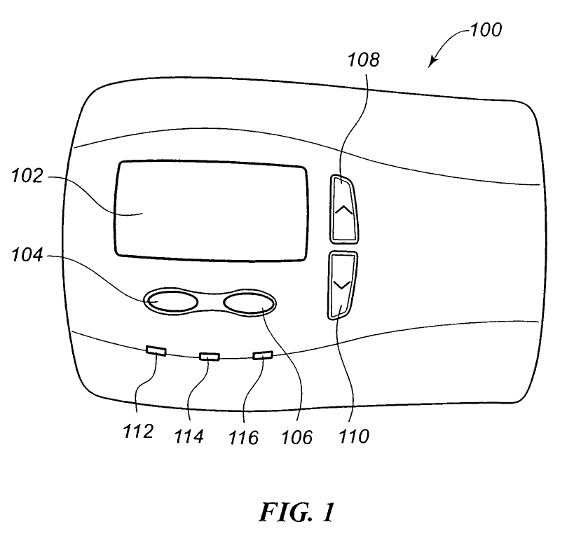

An embodiment of a thermostat constructed in accordance with the teachings of the present invention to incorporate the time of day zoning control of the HVAC system of the invention is illustrated in FIG. 1. As with many thermostats, an internal temperature sensor is included within the thermostat 100. As may be seen from this FIG. 1, this embodiment of the thermostat 100 includes a user display 102 on which is displayed programmatic, system, and ambient information regarding the operation of the HVAC system. This user display 102 may take various forms as are well-known in the art, and in a preferred embodiment is a dot matrix LCD display. With such a display 102, the consumer may activate various programmatic and control functions via a pair of soft keys 104, 106. The functionality executed by these soft keys 104, 106 varies dependent upon the programmatic state in which the thermostat 100 is at the time one of the soft keys 104, 106 is depressed. The particular functionality that will be instituted upon selection of one of the soft keys 104, 106 is displayed in an area of the user display 102 proximate the key 104, 106 which will institute that function. That is, the function that will be instituted upon selection of soft key 104 will be located generally in the lower left hand portion of user display 102 while the functionality that will be instituted by selection of soft key 106 will be located generally in the lower right hand portion of user display 102. These functional indicators may change depending on the program state and mode in which the thermostat is currently operating.

In addition to the soft keys 104, 106, this embodiment of the thermostat 100 of the present invention also includes adjustment keys 108, 110. These adjustment keys 108, 110 may serve to adjust a currently selected parameter up or down, such as in the case of setting the control temperature at which the thermostat will maintain the ambient environment. Additionally, these keys 108, 110 may scroll through the available data for a selected parameter, such as scrolling through alphanumeric data that may be selected for a given parameter. These keys 108, 110 may also function as soft keys depending on the programmatic state in which the thermostat is operating. When this functionality is provided, the function that will be instituted by selection of key 108 will be provided generally in the upper right hand corner of display 102, while the functionality that will be instituted by selection of key 110 will be displayed generally in the lower right hand corner of user display 102. In addition to the above, other use input means, such as an alphanumeric keypad, user rotatable knob, a touch screen, etc. may be utilized instead of the buttons 104-110 illustrated in the embodiment of FIG. 1.

In this embodiment, the thermostat 100 also includes operating mode visual indicators 112, 114, 116. These indicators 112-116 provide a visual indication of the current operating mode of the thermostat. In the embodiment illustrated in FIG. 1, indicator 112 will illuminate while the thermostat 100 is operating in the cooling mode. Indicator 116 will illuminate while the thermostat 100 is operating in the heating mode. Finally, indicator 114 will illuminate to indicate that the fan is operating. Depending on the particular application, this indicator 114 may illuminate whenever the fan is running, or may illuminate only when the fan is selected to run continuously.

In embodiments of the present invention that do not utilize automated switching control between the heating and cooling modes of operation, these indicators 112-116 may operate as user selectable switches to allow the consumer to select the operating mode of the thermostat 100. For example, during the summer months the consumer may select the cooling mode by depressing indicator 112. In this mode, the furnace will not be turned on even if the interior ambient temperature drops below the set point. To switch from the cooling to the heating mode of operation, the consumer, in this alternate embodiment, would need to select indicator 116 to allow the thermostat 100 to operate the furnace. Consumer selection in this embodiment of indicator 114 would operate the fan continuously, as opposed to its normal automatic operation based upon a call for cooling or heat by the thermostat 100. In a still further embodiment of the present invention, the indicators 112-116 may also be utilized to provide a visual indication of system trouble, or that there is a system reminder message being displayed on user screen 102.

Having discussed the physical structure of one embodiment of a thermostat 100 constructed in accordance with the teachings of the present invention, the discussion will now focus on the time of day zoning control of the HVAC system which forms an aspect of the present invention. Indeed, while the following discussion will utilize the structure of the thermostat 100 illustrated in FIG. 1, those skilled in the art will recognize that various other structures can be utilized without departing from the spirit and scope of the present invention. That is, regardless of the user input mechanisms utilized by the particular embodiment of the thermostat 100 of the present invention, the programmatic steps and display information provided in the following discussion may be used.

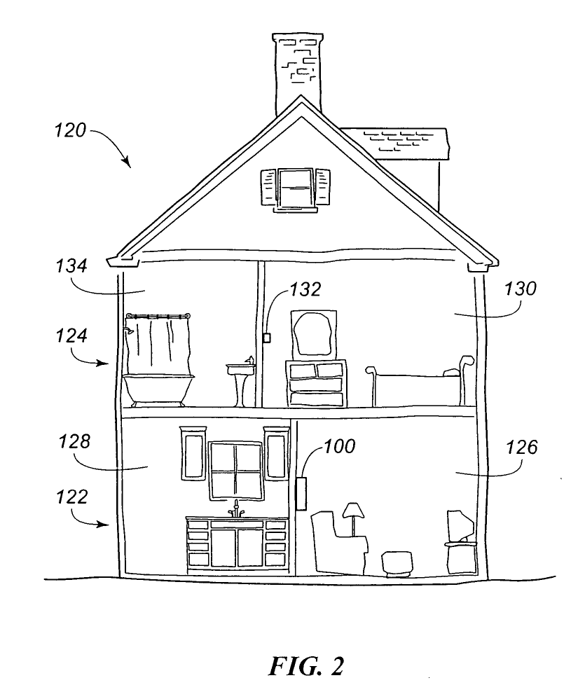

The time of day zoning provided by the thermostat 100 of the present invention may be better understood with reference to the simplified dwelling illustration of FIG. 2. This FIG. 2 is meant to illustrate, in simplified form, a two-story dwelling in which the system of the present invention may find particular applicability. This exemplary dwelling 120 includes both a first floor 122 and a second floor 124 on which occupants of the dwelling 120 may spend extended periods of time. Additional or fewer floors may also be provided in dwellings in which the system of the present invention may also find applicability.

In this simplified FIG. 2, a thermostat 100 is installed on the first floor 122 in an area 126 that is most likely to be occupied during certain periods of the day. While the first floor 122 also includes other areas 128 that may be occupied during the day, the exemplary system installed in the dwelling 120 of FIG. 2 does not include a remote temperature sensor in this other area 128. However, in other embodiments of the present invention, remote temperature and/or occupancy sensors may be installed in these other areas as desired by the consumer for regulation of the temperature therein based upon sensed or the likely occupancy of those areas during particular times of the day. Indeed, in embodiments where the thermostat 100 is installed in areas that are not typically occupied, e.g. a hallway, a remote temperature sensor may be installed in the areas 126 that are most likely occupied.

The second floor 124 of the exemplary dwelling 120 shown in FIG. 2 also includes an area 130 on the second floor 124 in which a remote temperature sensor 132 is installed. This area 130 was chosen for installation of the remote temperature sensor 132 based on the consumer's likely occupancy of this area 130 during particular times of the day. As with the first floor 122, the second floor 124 includes other areas 134 that may also be occupied during periods of the day, but in which the consumer has chosen not to install a remote temperature sensor. This decision to not install a temperature sensor in a particular area of the dwelling 120 is not based upon a limitation of the system of the present invention, but instead based on cost or other concerns of the consumer, or the consumer's lack of desire to provide specific temperature regulation of such areas during particular times of the day.

In the exemplary dwelling 120 shown in FIG. 2, the temperature regulated zone 126 on the first floor 122 may be, e.g., a family room or living room where the occupants of the dwelling spend a good deal of time throughout the day. The un-temperature-regulated area 128 of the first floor 122 may be a kitchen or dining room where the occupant is not so concerned with specific temperature regulation during the brief periods throughout the day when these areas are occupied. However, as indicated above, the system of the present invention can accommodate the installation of a remote temperature sensor in such areas to provide regulation thereof at the desire of the consumer.

The temperature regulated area 130 of the second floor 124 may be, for example, a bedroom or sleeping area where the occupants spend a significant period of time, typically during the nighttime hours. The un-temperature-regulated areas 134 may be, for example, a bathroom or other area that the consumer is not so concerned with specific temperature regulation therein. However, as discussed above, the system of the present invention would allow for the installation of a remote temperature sensor in these currently unregulated areas 134. The communication of temperature information from the remote temperature sensor 132 to the thermostat 100 may be via wired connection or wireless communication as is known in the art.

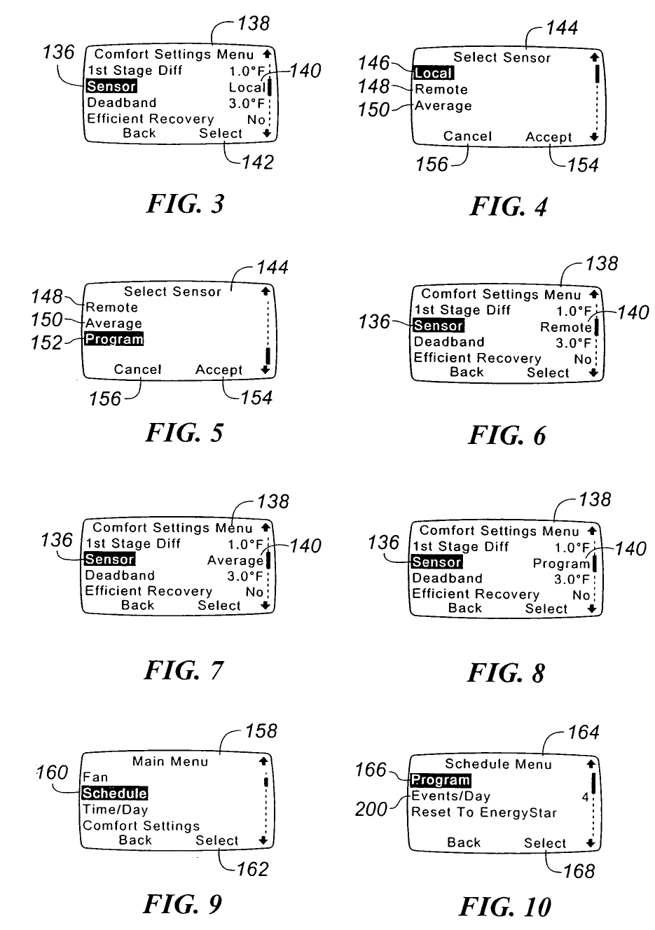

In an embodiment of the present invention that utilizes the soft key menu driven thermostat 100 illustrated in FIG. 1, the selection and programming of the thermostat 100 to utilize the internal and remote temperature sensors may be accessed through menus displayed on screen 102. In one embodiment of the present invention, a comfort settings menu, such as that illustrated in FIG. 3, may be accessed by a consumer to configure the system of the present invention. As illustrated in this exemplary menu of FIG. 3, a sensor setting 136 is displayed on the comfort settings menu 138. This sensor setting 136 includes an indication 140 of the current sensor setting for control of the HVAC system. To change this sensor setting 136, a user would depress soft key 106 (see FIG. 1) since this soft key 106 is in close proximity to the select functional indication 142.

Once this select functionality 142 has been indicated by the depression of soft key 106 (see FIG. 1), an embodiment to the present invention will display the select sensor menu 144 illustrated in FIG. 4. This select sensor menu 144 displays the available choices for control of the HVAC system based on temperature readings taken by the local or internal temperature sensor 146, by a remote temperature sensor 148, an average of the temperature readings from the temperature sensors 150 or, as illustrated in FIG. 5, a program setting 152. The additional options illustrated in the select sensor menu 144 of FIG. 5 are accessed by depression of the selection key 110 to scroll down to view the additional options that do not appear on the display. Once the user has selected the desired sensor via selection of selector keys 108, 110, the user would depress soft key 106 that is in proximity to the accept functionality 154. If, however, the user decided not to accept any changes to the selection sensor menu 144, the user could simply depress soft key 104 in proximity to the cancel functionality 156.

If the user were to select the remote temperature sensor 148 for regulation of the HVAC system, the display 102 would return to the comfort settings menu 138 illustrated in FIG. 6. As may be seem from this exemplary menu 138 in FIG. 6, the sensor selection 136 now indicates at 140 that the remote sensor will be utilized to control the HVAC system.

If, however, the user had selected the average selection 150 from the select sensor menu 144 of FIG. 4, the comfort settings menu 138 would indicate at 140 that the sensor selection 136 for control of the HVAC system is now set to average the temperature readings from the local and remote temperature sensors. This functionality will operate to control the HVAC system based on equally weighted average of the temperature sensed by both the internal or local temperature sensor and the remote temperature sensor(s) installed in the system.

Returning to the selection sensor menu 144 illustrated in FIG. 5, the system of the present invention also provides a program setting 152 that may be selected by depression of soft key 106 located in proximity to the accept functionality 154. Once the user selects the program functionality 152, the comfort settings menu illustrated in FIG. 8 will reflect this selection in area 140. Once this program functionality has been selected by the user, the user will then be able to program the thermostat 100 to use any one of the temperature sensors installed in the system, an average of such sensors, a weighted average of such sensors, or any combination thereof as desired.

In one embodiment of the present invention, the user of thermostat 100 may change the programming through the main menu 158 illustrated in FIG. 9. By using the select keys 108, 110 (see FIG. 1), the user can select the schedule option 160 by highlighting it and selecting the soft key 106 in proximity to the select functionality 162.

Once this selection has been made, an embodiment of the present invention displays a schedule menu 164 such as that illustrated in FIG. 10. From this schedule menu 164 the user is able to select the program functionality 166 by highlighting it using select keys 108, 110 and then depressing soft key 106 in proximity to the select functionality 168 displayed thereon.

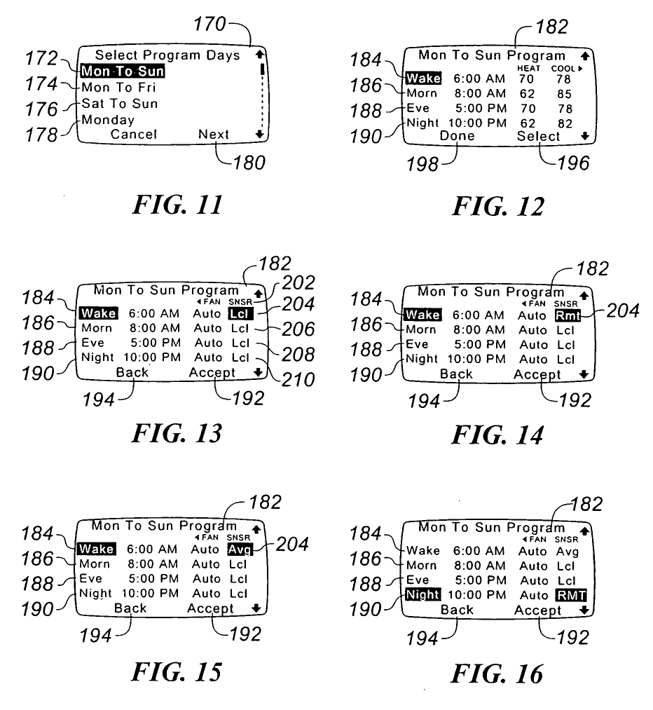

Once the program function 166 has been selected, and embodiment of the present invention displays a select program days menu 170 such as that illustrated in FIG. 11. This select program days menu 170 provides the user with various options to select different groupings of days, or individual days to establish a program for control of the HVAC system on those selected groupings of days or individual days as desired by the consumer. Preferably, an option 172 is provided to allow a consumer to set a single programming schedule for the entire week, an option 174 to allow a consumer to set a program schedule for the weekdays, an option 176, to allow a consumer to set a schedule for the weekend days, and a number of individual day options 178 that will allow a consumer to set individual programs for each particular day of the week. Once the desired grouping of days or individual day is selected via the select keys 108, 110, the consumer then depresses the soft key 106 in proximity to the next functionality 180 to proceed with the programming of the thermostat 100.

Assuming for this discussion that the consumer has selected the Monday to Sunday programming option 172, the Monday to Sunday program screen 182 illustrated in FIG. 12 is displayed. This full week programming menu 186 displays a number of events during each day to control the HVAC system, such as a wake period 184, a morning period 186, an evening period 188, and a night period 190. However, the number of events per day may also be changed in the system of the present invention by selecting the events/day option 200 from the schedule menu 164 illustrated in FIG. 10.

However, assuming that four events per day have been selected by the consumer as illustrated in FIG. 12, the consumer can change the programming of the options for each of these events by selecting the desired event through the selection keys 108, 110 (FIG. 1) and depressing soft key 106 in proximity to the select function 196. As the user cycles through each of the adjustable parameters for each of the events, e.g., time, heat temperature, cool temperature, fan operation, and sensor, the next adjustable parameter is selected.

As illustrated in FIG. 13, when the consumer has reached the sensor parameter 202 on the program menu 182, an indication is given at locations 204, 206, 208, 210 for each of the corresponding events 184-190, respectively, regarding what sensor or combination of sensors will be used to control the HVAC system. As indicated in FIG. 13, initially this embodiment of the present invention has the local or internal temperature sensor within thermostat 100 selected, as indicated by the Lcl indication, to control the HVAC system. This sensor may be changed by using the select keys 108, 110 (FIG. 1). FIG. 14 illustrates the program screen 182 as the user changes the option for the control sensor from local to the remote sensor, and FIG. 15 illustrates this screen 182 as the consumer changes to an average of the installed temperature sensors as indicated in location 204.

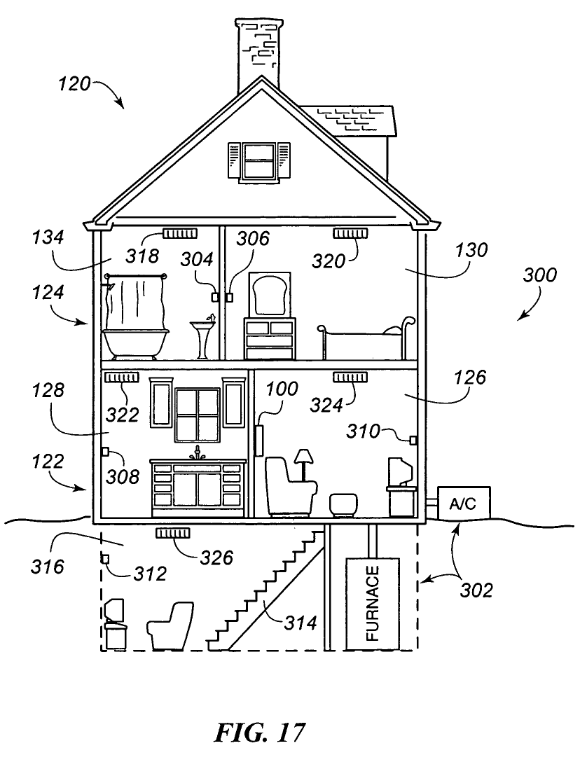

Once the consumer has reached the desired sensor for that event, the consumer depresses soft key 106 in proximity to the accept functionality 192. If, however, the consumer wanted to change a previous option, the consumer would depress soft key 104 in proximity to the back functionality 194. Once each of the programmable settings for each of the events have been programmed, the screen of FIG. 12 is then displayed to allow the user to select soft key 104 in proximity to the done functionality 198 to end the programming set-up. The thermostat will then control the HVAC system based on the programmatic inputs from the consumer. This control may be aided through the proper actuation of various dampers to restrict the flow of conditioned air to un-temperature-regulated areas and enhance the flow of conditioned air to the selected temperature-regulated areas as will be discussed more fully below with reference to FIG. 17.

As illustrated in FIG. 16, the consumer has indicated a desire in this example to have the HVAC system controlled based on an average of the local and remote sensors from 6:00 a.m. until 8:00 a.m., based on the local sensor from 8:00 a.m. until 10:00 p.m., and then based on the remote sensor from 10:00 p.m. until 6:00 a.m. the next morning. At any point, the consumer may modify the programming of the thermostat 100. Additionally, while not explicitly illustrated in screen shots, the system of the present invention also allows the various temperature sensors located throughout the dwelling or structure to be given a weighting factor as opposed to a straight averaging of the inputs therefrom for control of the HVAC system. This weighting can be adjusted based on sensed occupancy of those other areas.

As discussed briefly above, one embodiment of present invention provides the thermostat 100 with an air distribution control capability. In that regard and referring to FIG. 17, a conditioned air distribution and control system 300 for managing the HVAC system 302 and the temperature of a room, micro-zone, and/or area 126-134, 316 within a dwelling 120 or structure is illustrated. While not required in the embodiments discussed above that utilize straight time of day zoning, other embodiments of the distribution and control system 300 includes a number of occupancy sensors 304, 306, 308, 310, 312 that communicate with the programmable thermostat 100.

In the illustrated embodiment, at least one of the occupancy sensors 304-312 is deployed in each one of the areas 126-134, 316. Preferably, at least one of the occupancy sensors 304-312 is present on the first 122 and second 124 floors, as well as in the basement 316 in the dwelling 120. The occupancy sensors 304-312 are able to sense a state of occupancy in their respective area 126-134, 316. In other words, each of the sensors 304-312 is able to determine if the particular area 126-134, 316 in the dwelling 120 where that sensor is located happens to be occupied or unoccupied by residents, guests, and the like.

Each one of the occupancy sensors 304-312 can be one of a variety of suitable sensors such as, for example, a passive infrared sensor, an audible sensor, an ultrasonic sensor, and a microwave emitter sensor. Depending on the particular type selected, the occupancy sensors 304-312 are configured to detect either heat, sound, movement, etc. which is indicative of occupancy. When such occupancy is detected, the occupancy sensor 304-312 transmits the information or a signal to the thermostat 100, via a wired or wireless communication channel. The thermostat 100 processes the received information to make a determination that the particular area or room is either occupied or unoccupied. e.g. as determined from a lack of receipt of a signal or information from the occupancy sensor.

In one embodiment, the occupancy sensors 304-312 include a temperature and/or humidity sensor such as, for example, the remote temperature sensor 132 depicted in FIG. 2. The temperature and/or humidity transducer can be mounted along with, proximately located, and/or integrally formed with the occupancy sensors 304-312. Therefore, in addition to detecting a state of occupancy, the occupancy sensors 304-312 in one embodiment are able to observe the temperature and/or humidity within one of the areas 126-134, 316. In addition, the occupancy sensors 304-312 can include a microcontroller, control logic in the form of software and/or firmware, a battery, a power supply, a memory, and like components.

The thermostat 100 communicates with the occupancy sensors 304-312 such that the state of occupancy and other data sensed by each sensor is provided to the thermostat 100. The occupancy sensors 304-312 can transmit information to the thermostat 100 oil an immediate or real time basis, on a periodic basis, pursuant to a schedule, and the like. The thermostat 100 is able to collectively or individually consider and use the information received from the occupancy sensors 304-312. In other words, the thermostat 100 can rely on information from a lone sensor or from several of the sensors in controlling and managing the HVAC system 302. Therefore, when disposed in the air distribution and control system 300, the thermostat 100 controls the HVAC system 302 based on the state of occupancy reported by one or more of the occupancy sensors 304-312 (as well as any information provided by the temperature/humidity transducer). In one embodiment this occupancy control can augment or override the time of day zoning discussed above.

In a further embodiment of the present invention, the thermostat 100 includes special programming scripts or control schemes to accommodate circumstances outside those expected by the “normal” programming/mode settings of conventional thermostats. For example, if the thermostat 100 is informed by the occupancy sensors 304-312 that there has been no activity within any of the areas 128-134 of the dwelling for a predetermined amount of time (e.g., twenty-four hours, several days, etc.), the thermostat can transition to a set back or “vacation mode” and control the HVAC system 302 accordingly. On the other hand, if the thermostat 100 is informed that a significant amount of activity or occupancy is reported in the dwelling such as, for example, during a party, the thermostat can instruct the HVAC system 302 to deliver an increased amount of air conditioning to the area or areas 126-134, 316 where party guests have congregated.

In one embodiment a programming script is provided to handle a situation where, in the winter, one or more of the occupancy sensors 304-312 detects repeated activity in an area 126-134, 316 near a door (not shown) that leads out of the dwelling 120. Such activity might very well be the result of the door being opened a significant number of times or being opened for an extended period of time. This can be the result of, for example, numerous guests entering the dwelling 120, a smoker repeatedly escaping to the patio to satisfy a craving, several packages being moved into or out of the dwelling, and the like. Each time the door is opened or held open for a long time, a blast of cold air is allowed to enter the dwelling 120. That blast of cold air might, for example, quickly descend down a set of stairs 314 and into a basement area 316 (e.g., a den) and thereby avoid detection by the thermostat 100. As a result, the thermostat 100 is only able to detect and react to the cold air after that cold air has slowly diffused throughout the dwelling 120.

The programming script associated with the blast or repeated blasts of cold air permits the thermostat 100 to temporarily ramp up the set point temperature for the HVAC system 302. This permits the HVAC system 302 to increase the average heat output and/or process the chilly air that entered the dwelling more rapidly. With the occupancy sensors 304-312 and programming script in place to recognize and handle this situation, the thermostat 100 is able to more quickly instruct the HVAC system 302 and respond to the change in load. The sooner the HVAC system 302 can respond to the change in load, the more comfortable the occupants of the dwelling 120 will feel.

In a further embodiment, a programming script is provided to accommodate relatively high levels of sensed activity or occupancy on the first floor 122 or in the basement 316 where cooler air tends to concentrate. In such a case, the script commands a “fan only” mode, where the fan in the HVAC system 302 runs intermittently, in lieu of an “air conditioning” mode which demands much more energy and is therefore more expensive. This is possible because the system can redistribute cooler air from unoccupied areas to the area of concentration of the occupants. In a further embodiment a script accommodates relatively high levels of sensed activity or occupancy on the second floor 124 where warmer air tends to concentrate. In such a case, the thermostat 100 provides a lower cooling set point and a longer HVAC system run time to provide better air conditioning to the second floor 124.

To ensure that the HVAC system 302 is able to handle the changing conditions in the dwelling 120, the thermostat 100 in one embodiment controls the HVAC system 302 to incrementally adjust the temperature of one or more of the areas 128-134. This incremental control by the thermostat 100 utilizes a series of stepped or tiered set points after the thermostat 100 has determined an occupied or unoccupied state of occupancy for a predetermined period of time. The series of stepped or tiered set points is programmable into the thermostat 100 by a control system user, installer, retailer, manufacturer, and the like. In this way, the occupied areas can be brought back to comfortable conditions more rapidly when the occupancy changes. For example, all because the downstairs 122 has been unoccupied for 12 hours during the night and early morning, the thermostat 100 will not set the downstairs settings to a vacation mode where the temperature may be allowed to drop to sixty degrees. Instead, the temperature may be lowed to a first stage in anticipation of re-occupancy in the near future. However, if the dwelling remains unoccupied for a much greater period of time, the thermostat 100 may go ahead and continue to lower the temperature set point to increase energy efficiency as it becomes clear the occupants have left for an extended period.

As discussed briefly above, in one embodiment of the invention the system 300 includes a number of damper mechanisms 318, 320, 322, 324, 326 for controlling air flow into the areas 126-134, 316 in the dwelling. The damper mechanisms 318-326 are generally motor or solenoid driven vanes, grates, louvers, bellows or the like. The damper mechanisms 318-326 permit an otherwise static HVAC system 302 to be more dynamic. While generally configured to communicate with the thermostat 100, in one embodiment the damper mechanisms 318-326 are equipped for wireless communication with the thermostat 100. In that regard, the damper mechanisms 318-326 can include, for example, a radio frequency transmitter and/or receiver. These dampers may be used with the time of day zoning embodiment of the present invention discussed above to further effectuate the zoning temperature regulation and to enhance energy savings by reducing conditioned airflow into unregulated areas. These dampers may also be used with other embodiments of the present invention as will be discussed more fully below.

In one embodiment, each of the damper mechanisms 318-326 is associated with one of the occupancy sensors 304-312. For example, the damper mechanism 318 may be exclusively associated with the occupancy sensor 304 (because they are in the same area 134) and the damper mechanism 320 may be exclusively associated with the occupancy sensor 306 (because they are in the same area 130). By relating each of the occupancy sensors 304-312 to one of the damper mechanisms 318-326, the thermostat 100 can provide more targeted zone control of the HVAC system 302 to enhance energy efficiency while ensuring occupant comfort. This is accomplished by the thermostat 100 in one embodiment by opening or more fully opening dampers 318-326 in occupied areas and closing or more fully closing dampers 318-326 in unoccupied areas. In a preferred embodiment, the thermostat 100 does not completely close a damper 318-326 in any area that is likely to be or has been occupied in the past so that the environment in that area is not unduly uncomfortable if an occupant moves into that area.

In a further embodiment, at least one of the damper mechanisms 318-326 is assigned an operational profile related to one or more of a heating/cooling mode of the HVAC system 302, a time of day, and a time of year. The operational profile of each damper mechanism 318-326 dictates how the damper will be positioned during a particular mode, at a particular time of day or year, and the like. Also, at least one of the damper mechanisms 318-326 is assigned an identification or priority number. These operational profiles, identification numbers, and priority rankings are programmable into the thermostat 100 to assist the thermostat 100 in instructing and/or managing the HVAC system 302.

In one embodiment, zone or room names are assigned to one or more of the occupancy sensors 304-312 and/or the damper mechanisms 318-326 and programmed into the thermostat 100. For example, the occupancy sensor 304 and the damper mechanism 318 can be assigned to the bathroom (e.g., area 134), the occupancy sensor 306 and the damper mechanism 320 can be assigned to the bedroom (e.g., area 130), the occupancy sensor 308 and the damper mechanism 322 can be assigned to the kitchen (e.g., area 128), the occupancy sensor 310 and the damper mechanism 324 can be assigned to the living or television room (e.g., area 126), and the occupancy sensor 312 and the damper mechanism 326 can be assigned to the den or basement (e.g., area 316), etc. When these logical room assignments are programmed into the thermostat 100, specific temperature set points for each of the rooms can be stored in a memory within the thermostat 100. As such, whenever activity is sensed in one of the areas 126-134, 316, the thermostat 100 can access the stored set point for that particular area and instruct the HVAC system 302 accordingly. As an occupant of the dwelling migrates from area to area during the day and night, the thermostat 100 is able to automatically accommodate the occupied area for the comfort of the occupant.

In operation, the air distribution and control system 300 controls a temperature (or other environmental characteristic) of an area 126-134, 316 based on occupancy of that area, either by anticipating such occupancy based on time of day zoning, by actually sensing a state of occupancy of one or more of those areas, or a combination of these. Based on the sensed state of occupancy, the thermostat 100 instructs the HVAC system 302 to adjust the temperature of the area 126-134, 316 such that the temperature of the area within the dwelling 120 is controlled for comfort and/or energy efficiency. When damper mechanisms 318-326 are included in the dwelling 120, the thermostat 100 can further dynamically control the temperature of a particular area 126-134, 316 based on the state of occupancy by opening or closing one or more of the damper mechanisms. In other words, the damper mechanisms 318-326 can be selectively employed by the thermostat 100 to augment the adjustment of temperature within the dwelling 120 to enhance comfort and energy efficiency. The exchange of information between all components, including the sensed state of occupancy, can be accomplished via wired and/or wireless communication.

The thermostat 100 is further able to access at least one or more of the programmed operating, modes, scripts, and/or schemes to facilitate the adjustment of a temperature or other environmental condition within the dwelling 120. Therefore, during operation, should a sensed occupancy advise the thermostat 100 of an unusual condition or activity in one of the areas 126-134, 316, the thermostat can respond accordingly and ensure occupant comfort and/or energy efficiency.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A heating, ventilating and air conditioning (HVAC) system control system, comprising:
a programmable thermostat;
at least two temperature sensors in communication with the thermostat, a first one of the at least two temperature sensors adapted to be located in a first area and a second one of the at least two temperature sensors adapted to be located in a second area;
means for determining occupancy of at least one of the first area or the second area; and
wherein the thermostat is programmable to control the HVAC system based at least in part on a first temperature sensed by the first one of the at least two temperature sensors when the means determines that the first area is occupied.

2. The system of claim 1, wherein the thermostat is programmable to control the HVAC system based at least in part on a second temperature sensed by the second one of the at least two temperature sensors when the means determines that the second area is occupied.

3. The system of claim 1, wherein the means comprises time of day zoning programming of the thermostat.

4. The system of claim 1, wherein the means comprises a first occupancy sensor in communication with the thermostat and adapted to be located in the first area.

5. The system of claim 4, wherein the means further comprises a second occupancy sensor in communication with the thermostat and adapted to be located in the second area.

6. The system of claim 4, further comprising a first damper adapted to be located in the first area and operable to control a flow of conditioned air into the first area, the thermostat being in communication with the first damper to control operation thereof based on the means for determining occupancy.

7. The system of claim 6, wherein the thermostat and the first damper are configured for wireless communication with at least one another.

8. The system of claim 4, wherein the thermostat and the first occupancy sensor are configured for wireless communication with at least one another.

9. The system of claim 4, wherein the thermostat is programmed with a special programming script to control operation of the HVAC system upon an anomalous occupancy condition sensed by the first occupancy sensor.

10. The system of claim 4, wherein the first occupancy sensor is selected from the group consisting of an infrared sensor, an audible sensor, an ultrasonic sensor, and a microwave emitter sensor.

11. The system of claim 4, wherein, when the first occupancy sensor indicates to the thermostat that the first area is occupied the thermostat is configured to control the temperature in the first area for occupant comfort and, when the first occupancy sensor indicates to the thermostat that the first area is unoccupied the thermostat is configured to control the temperature in the first area for energy efficiency.

12. The system of claim 4, wherein the programmable thermostat is configured to control the temperature of the first area based on a plurality of stepped set points after the first occupancy sensor has indicated to the thermostat that the first area is unoccupied for a predetermined period of time.

13. A control system for managing a heating, ventilating and air conditioning (HVAC) system to control a temperature of at least two areas within a structure, the system comprising:
a first occupancy sensor disposed in a first area to sense a first state of occupancy of the first area;
a second occupancy sensor disposed in a second area to sense a second state of occupancy of the second area;
a first damper mechanism positioned in the first area for controlling a flow of conditioned air into the first area;
a second damper mechanism positioned in the second area for controlling a flow of conditioned air into the second area; and
a programmable thermostat remotely disposed from and in communication with the first and second occupancy sensors and the first and second damper mechanisms, the programmable thermostat controlling the first and second damper mechanisms based on the first and second states of occupancy sensed by the first and second occupancy sensors.

14. The system of claim 13, wherein the first damper mechanism is exclusively associated with the first occupancy sensor and the second damper mechanism is exclusively associated with the second occupancy sensor.

15. The system of claim 13, wherein the control system further comprises a first temperature sensor disposed in the first area and a second temperature sensor disposed in the second area, the first and second temperature sensors in communication with the programmable thermostat, wherein the programmable thermostat regulates the temperature of the first area based on information received from the first temperature sensor when the first occupancy sensor indicates that the first area is occupied, and wherein the programmable thermostat regulates the temperature of the second area based on information received from the second temperature sensor when the second occupancy sensor indicates that the second area is occupied.

16. The system of claim 13, wherein the at least one of the first and second damper mechanisms is assigned an operational profile related to one or more of a heating/cooling mode of the HVAC system, a time of day, or a time of year.

17. The system of claim 13, wherein the programmable thermostat is programmed with a special programming script to control operation of the HVAC system upon an anomalous occupancy condition sensed by the first occupancy sensor.

18. A method of controlling a temperature of an area within a structure, the method comprising the steps of:
determining a state of occupancy of the area; and
adjusting the temperature of the area based on the sensed state of occupancy.

19. The method of claim 18, wherein the step of adjusting comprises the step of varying a flow of air into the area.

20. The method of claim 18, wherein the step of determining the state of occupancy of the area comprises the steps of determining a current time of day and inferring occupancy of the area based on the current time of day.

21. The method of claim 18, wherein the step of determining the state of occupancy of the area comprises the step of sensing a presence or absence of an occupant in the area.
